(19) United States
(12) Patent Application Publication
(10) Pub. No.: US 2018/0091213 A1
(43) Pub. Date: Mar. 29, 2018

(54) MOBILE BASE STATION RECEIVER DIGITALIZATION CAPACITY ENHANCEMENT USING COMBINED ANALOG SIGNALS

(71) Applicant: NOKIA SOLUTIONS AND NETWORKS OY, Espoo (FI)

(72) Inventor: Jukka KAREISTO, Kempele (FI)

(21) Appl. No.: 15/277,643

(22) Filed: Sep. 27, 2016

(51) Int. Cl. H04B 7/08

(52) U.S. Cl. CPC H04B 7/0868; H04B 7/086

(57) ABSTRACT

Various communication systems may benefit from capacity enhancement. A method can include receiving, via a first antenna, a first signal on a first analog radio frequency. The method can also include receiving, via a second antenna, a second signal on a second analog radio frequency. The second analog radio frequency can be at least partially overlapping with the first analog radio frequency. The method can further include offsetting the second analog radio frequency to an offset frequency. The first analog radio frequency and the offset frequency can be within a processing bandwidth of a digitizer. The method can additionally include combining the first signal and the second signal to form a combined signal. The method can also include digitizing the combined signal to provide an output representative of a digitization of the first signal separated from the second signal in a single digitizing chain.

### BACKGROUND

### Field

Various communication systems may benefit from capacity enhancement. For example, certain wireless communication systems may benefit from mobile base station receiver digitalization capacity enhancement using combined analog signals.

### Description of the Related Art

Different types of fast sampling technology receiver solutions with wide digitalization sampling bandwidths may offer capacity for sampling wanted received (RX) signals. This available wide digitalized band is only partly used in conventional systems. For example, each digitalization chain is only capable of handling one same frequency range digitalization, even if a system is receiving multiple signals in the same frequency range.

This limitation is based on the fact that each digitalized branch is sampling wanted signals to the same baseband (BB) frequency because of specific sampling speed. Therefore, even if there is free digitalization bandwidth available inside a single chain it is not possible add two or several same analog frequency range RX-chains to one digitalization chain. Thus wide bandwidth-sampling receiver technologies are limited and single digitalization chain bandwidth cannot conventionally convert several same frequency range bands from different antenna chains at the same time.

RX-chains with wide digitalization bandwidth conventionally use structures where only one frequency range RF-chain signal can be digitalized at each digitalization chain. FIG. 1 illustrates a scenario where each digitalization chain converts a single analog RX-chain.

FIG. 1 presents a general example of how current wide bandwidth RX RF-chains are sampling each digitalized RX-signals to the baseband digitalization band. Each chain is able to convert only one same RF-frequency range signal to the available baseband spectrum.

### SUMMARY

According to certain embodiments, a method can include receiving, via a first antenna, a first signal on a first analog radio frequency. The method can also include receiving, via a second antenna, a second signal on a second analog radio frequency. The second analog radio frequency can be at least partially overlapping with the first analog radio frequency. The method can further include offsetting the second analog radio frequency to an offset frequency. The first analog radio frequency and the offset frequency can be within a processing bandwidth of a digitizer. The method can additionally include combining the first signal and the second signal to form a combined signal. The method can also include digitizing the combined signal to provide an output representative of a digitization of the first signal separated from the second signal.

In certain embodiments, an apparatus can include a first receiver configured to receive a first signal on a first analog radio frequency. The apparatus can also include a second receiver configured to receive a second signal on a second analog radio frequency. The second analog radio frequency can be at least partially overlapping with the first analog radio frequency. The apparatus can further include a first frequency converter configured to offset the second analog radio frequency to an offset frequency. The first analog radio frequency and the offset frequency can be within a processing bandwidth of a first digitizer. The apparatus can additionally include a first signal combiner configured to combine the first signal and the second signal to form a combined signal. The apparatus can also include the first digitizer configured to digitize the combined signal to provide an output representative of a digitization of the first signal separated from the second signal.

An apparatus, according to certain embodiments, can include means for receiving, via a first antenna, a first signal on a first analog radio frequency. The apparatus can also include means for receiving, via a second antenna, a second signal on a second analog radio frequency. The second analog radio frequency can be at least partially overlapping with the first analog radio frequency. The apparatus can further include means for offsetting the second analog radio frequency to an offset frequency. The first analog radio frequency and the offset frequency can be within a processing bandwidth of a digitizer. The apparatus can additionally include means for combining the first signal and the second signal to form a combined signal. The apparatus can also include means for digitizing the combined signal to provide an output representative of a digitization of the first signal separated from the second signal.

### BRIEF DESCRIPTION OF THE DRAWINGS

For proper understanding of the invention, reference should be made to the accompanying drawings, wherein:

FIG. 1 illustrates a scenario where each digitalization chain converts a single analog RX-chain.

FIG. 2 illustrates a block diagram of a system with multiple digitalization chains according to certain embodiments.

FIG. 3 illustrates a block diagram of a system with a single digitalization chain digitizing multiple analog RF-signals from the same frequency, according to certain embodiments.

FIG. 4 illustrates a challenge to combining multiple RX-chains from the same frequency to a single digitalization sampling chain.

FIG. 5 illustrates a method according to certain embodiments.

FIG. 6 illustrates a block diagram of a system according to certain embodiments.

### DETAILED DESCRIPTION

Certain embodiments provide up-link capacity enhancement technology for the different types of mobile base station structures. For example, certain embodiments may allow more effective use of each sampled in-phase and quadrature (IQ) RX-chain to handle a larger quantity of wanted radio frequency (RF) signals with each individual digitalization chain.

Certain embodiments may permit digitalization, for example sampling, of several same-frequency RX-chains from different antenna chains in a single digitalized chain. The RX-chains can be considered same-frequency if they have an at least partially overlapping RF signal spectrum, a same center frequency, or otherwise similarly overlap or share the same RF bandwidth. As a result, the quantity and overall bandwidth for combined analog or RF signals can be based on available baseband digitalization bandwidth where wanted RF-signals are mixed. With techniques according to certain embodiments, single digitalized chain capacity can be effectively multiplied. With technology according to certain embodiments, available digitalization chain bandwidth (BW) may be used with higher efficiency to carry out a greater amount of digitization of wanted signals.

As a result, in certain embodiments fewer digitalization chains may be needed to cover a total amount of analog receiver antenna chains. Depending on the use case, each RX-chain capacity may possibly be doubled. Other improvements or other degrees of improvement are also possible. For example, in contrast to certain conventional approaches, in certain embodiments it is possible to include two or even more signals, on a same frequency as one another, from different antenna chains inside one digitalization chain sampling frequency range. Accordingly, certain embodiments may allow cost effective and higher efficiency receiver chain implementation.

Certain embodiments can increase digitalization chain capacity in a variety of systems. For example, certain embodiments are applicable to active antenna systems, fifth generation (5G) solutions and different types of wireless base transceiver station (BTS) network receiver solutions.

Certain embodiments may use available digitalization BW more effectively. Certain embodiments may provide applicable frequency difference at the RX-chain analog parts separating RX-bands of different RX chains from each other. An available frequency range for locating analog chains spectrum can be as high as an available digitalization bandwidth, depending on the used sampling rate and RX-chain topology.

After each wanted frequency band is shifted to its own individual analog frequency range within the available digitalization bandwidth limitations, signals can be combined back to one signal chain. With this technique it may be possible to combine RX-frequency bands from different antenna chains into one digitalization chain. Moreover, in this way the digitalization chain bandwidth can be used more effectively.

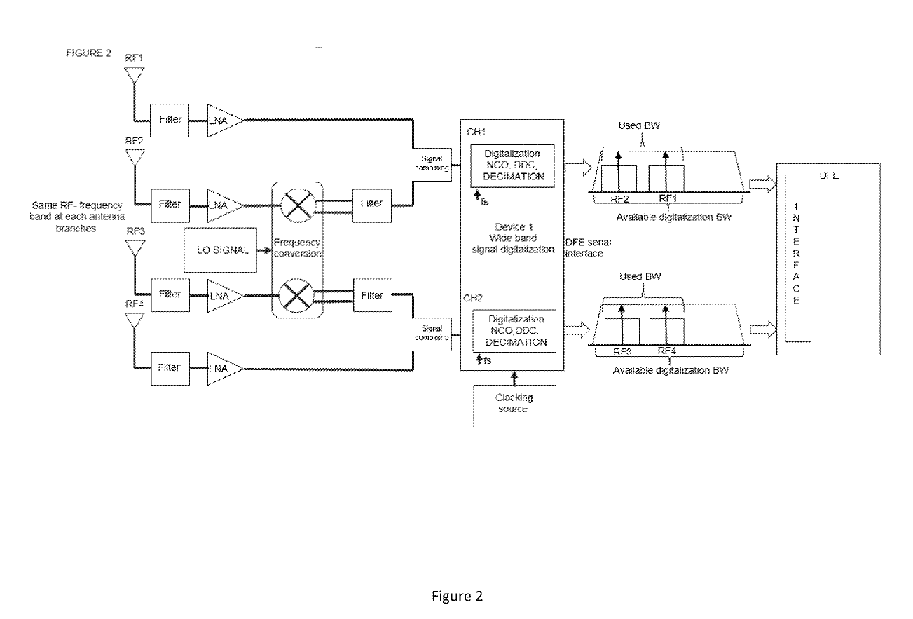

FIG. 2 illustrates a block diagram of a system with multiple digitalization chains according to certain embodiments. More particularly, FIG. 2 illustrates a block diagram where radio frequency (RF) signals received via four RX-receiver chains can be digitalized using two digitalization chains. In FIG. 2, RF1 and RF2 antenna chains can be, for example, base station main and diversity chains. The antenna chains can also have other designations, such as ANT1, ANT2, ANT3, and so on. Selected antenna chains RX-signals can be provided with frequency separation within the digitalization BW. Such separation may help to provide good performance and avoid mirror frequency effect or other issues.

The frequency conversation can rely on a local oscillator (LO) signal. The LO frequency for frequency separation can be generated directly at the clocking source by dividing clocking voltage-controlled oscillator (VCO) core frequency with a certain dividing ratio or, as another example, by using a separate VCO synthesizer, depending on a desired use case.

Thus, FIG. 2 presents an example of a topology where four same frequency range RX-antenna chains can be digitalized using two total digitalization branches. Each digitalization chain can convert two analog RF-input signals. Same frequency analog input signals can be first separated to different analog frequencies and then combined back to provide one digitalization input. The needed LO for the mixer can be distributed directly at the clocking source.

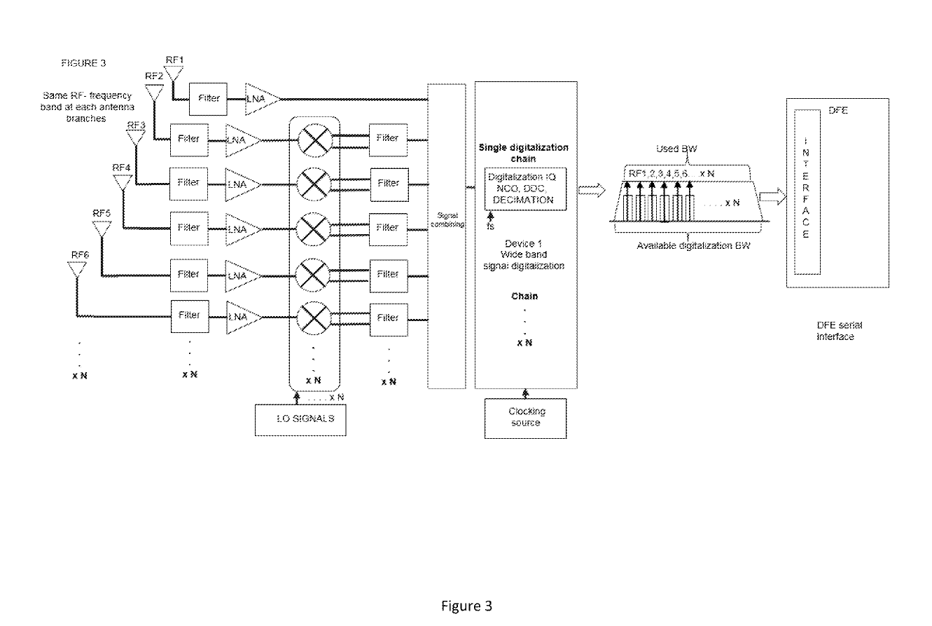

FIG. 3 illustrates a block diagram of a system with a single digitalization chain according to certain embodiments. FIG. 3 presents an example use case block diagram of a topology in which several, in this case N, RX-chains can be digitalized with one digitalization chain.

More particularly, FIG. 3 presents a scenario in which several same frequency range RX-antenna chains, for example 5G beam forming or active antenna systems, are digitalized with one digitalization chain. The analog RF-signals from different antennas are mixed at different analog frequencies within the available digitalization bandwidth limitation and then combined back to the same digitalization chain.

Thus, certain embodiments can be implemented to provide multiple RX-receiver chain digitalization capacity by adding two or more wanted same frequency band signals in one digitalization chain. Available digitalization baseband bandwidth can thus be used more effectively and with less hardware (HW) structures needed to cover a total amount of base station antenna lines.

Compared to previous approaches in which each antenna reception chain had its own digitalization chain, a single digitalization chain may now be able to digitalize both main and diversity RX-chains that are at the same frequency band. Moreover, this technology can be implemented for all sampling technology receiver solutions where wide digitalization bandwidth is available. As explained above, FIG. 2 presents an example of doubling receiver chains amount using a single digitalization chain configuration. FIG. 3 presents a more general idea of how even more same frequency bands RX-chains can be combined into the one digitalization chain.

Certain embodiments also permit the addition of monitoring and testing features in the same digitalization chain with traffic signals. These features are for example certain frequency band monitoring and digitalization within the free range of digitalization bandwidth.

Certain embodiments can increase digitalization chain capacity applicable to active antenna systems, 5G receiver and beam forming solutions, and different wireless base transceiver station (BTS) network receiver solutions.

Certain embodiments can be used in a variety of different use cases, of which the following are some examples. Certain embodiments may apply, for example, to BTS RX-receiver chains solutions where several same frequency range antenna chains are digitalized at single digitalization chain. Likewise, certain embodiments may increase receiver chain quantity per single digitalization chain at 5G solutions where several receiver chains needed for beam forming solutions.

Additionally, certain embodiments may apply to active antenna solutions to multiply RX-digitalization chain capacity. Likewise certain embodiments may permit BTS RX chains for Main and Diversity digitalization to be accomplished at a single digitalization chain.

As mentioned above, certain embodiments may be used for mobile and wireless technology testing and monitoring purposes. The same digitalization chain can be configured to handle several wanted input signals within the digitalization bandwidth. Furthermore, certain embodiments may provide power saving for, for example, mobile base station RX-solutions.

In conventional approaches each digitalization chain is only able to handle one same frequency range chain digitalization. Moreover, the same analog frequency signals from different antenna chains become the same base band frequency after sampling. Wide bandwidth sampling technologies allows handling wide input frequency range at the same time. It also can handle dual band frequency inputs digitalization at the same time. However, even when wide input frequency range is available, a single chain cannot successfully digitalize the same frequency ranges from different RX-chains at a single digitalization chain in a conventional system.

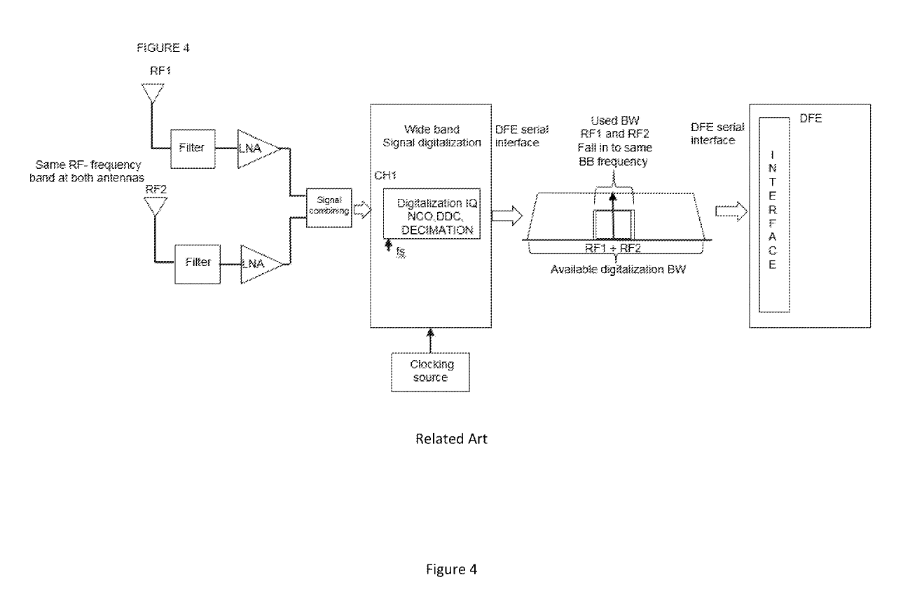

FIG. 4 illustrates a challenge to combining multiple RX-chains from the same frequency to a single digitalization chain. FIG. 4 presents a general example to clarify limitations on conventional approaches. As shown in FIG. 4, the same analogue frequency bands are falling into the same BB digitalization band after sampling. Thus, to successfully also digitalize a second RF chain, RF2 chain, more digitalization chains are conventionally needed.

More generally, FIG. 4 presents the wide bandwidth RX-chain digitalization challenge and basic theory as to why it is not possible to add same frequency bands signals to one wide bandwidth digitalization chain in a conventional arrangement. The same frequency range analog signals from different antenna chains would fall into the same base band frequency after digitalization. In dual band cases this structure may be sufficient because the analog signals already have frequency difference, and thus would fall into different ranges in the base band. Nevertheless, this may not be effective in case the same frequency bands are received with one digitalization chain.

The technology according to certain embodiments can be implemented at, for example, any receiver topology where IQ sampling technology is used. This technology may also be capable for RF analog to digital conversion (RF ADC) sampling topology receiver chains. This technology can also be used in 5G and active antenna solutions where a high amount of the antenna chains may be needed for beam forming solutions.

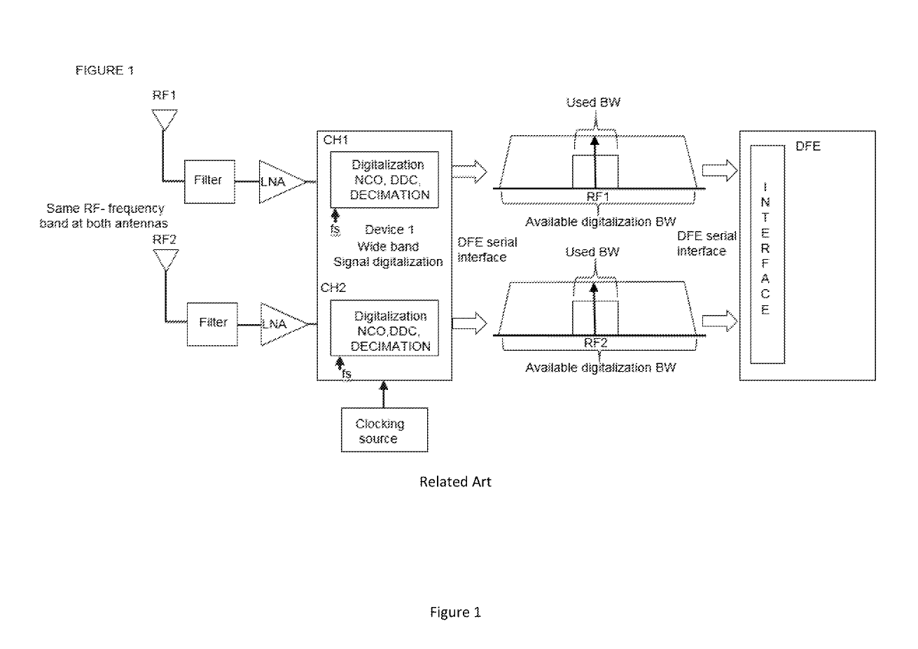

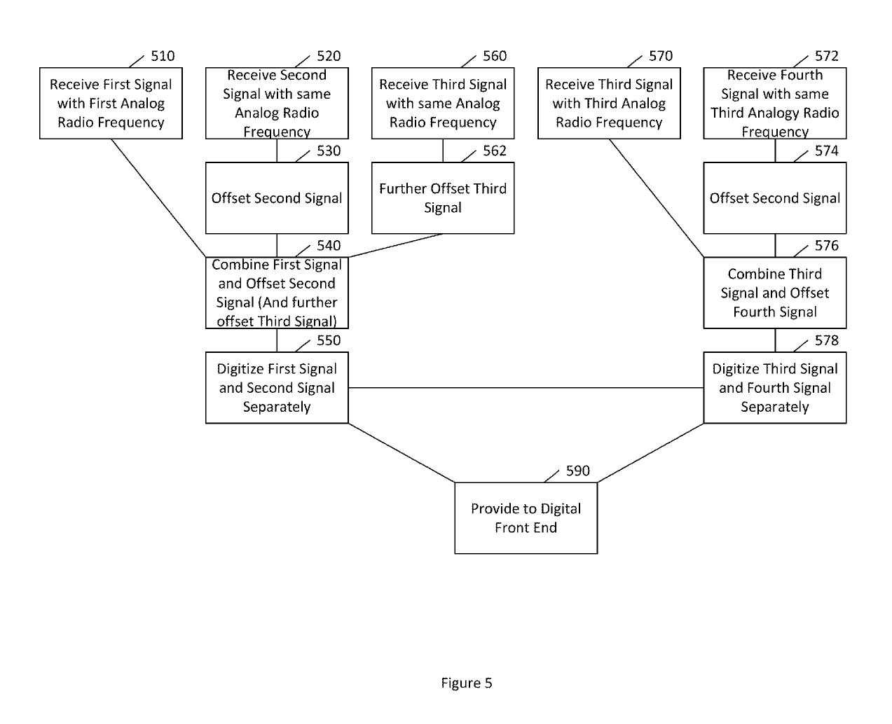

FIG. 5 illustrates a method according to certain embodiments. As shown in FIG. 5, a method can include, at 510, receiving, via a first antenna, a first signal on a first analog radio frequency. The first signal can be, for example, a base station main signal. The signal can be considered the same signal even after being passed through such equipment as an optional filter and low-noise amplifier, as illustrated in FIGS. 1 through 4.

As shown in FIG. 5, the method can also include, at 520, receiving, via a second antenna, a second signal on a second analog radio frequency. The second analog radio frequency can be at least partially overlapping with the first analog radio frequency. The first signal and the second signal can be considered to be on the same analog radio frequency if the two signals are on fully overlapping or partially overlapping frequencies. The second signal can be, for example, a base station diversity signal. The frequency can be the same without requiring a precise mathematical equivalence. For example, if both signals are considered to be at or from the same RF-frequency of a communication system and are potentially using the same frequency within the design of that system, they may be considered as having the same frequency. The frequency of the signal can be considered after processing by the filter or other equipment to remove unwanted noise. In certain cases, the signals can be considered to be on the same frequency if they use the same notch filter in the reception path to filter for the same range of frequencies. Likewise, the signals can be considered to be the same if, for example, when down-sampled they would overlap with one another at the baseband frequency.

The method can further include, at 530, offsetting the second analog radio frequency to an offset frequency. The first analog radio frequency and the offset frequency can be within a processing bandwidth of a digitizer. This processing bandwidth can be, for example, a sampling bandwidth. For example, as mentioned above, the digitizer may have a wide processing bandwidth and the first analog radio frequency can occupy one portion of that wide processing bandwidth, while the second analog radio frequency can occupy another portion of that same wide processing bandwidth. Optionally, both the first signal and the second signal can be offset with different offsets.

The method can additionally include, at 540, combining the first signal and the offset second signal to form a combined signal. The method can also include, at 550, digitizing the combined signal to provide an output representative of a digitization of the first signal separated from the second signal. Digitizing and digitalizing can refer to the same process, as described herein. The separation can be made by outputting the digitized first signal in a first baseband bandwidth portion and the second signal in a second non-overlapping baseband portion. Optionally, the baseband output can be filtered to provide fully separated baseband outputs.

The method can optionally include, at 560, receiving via a third antenna, a third signal on a third analog radio frequency. The third analog radio frequency can be at least partially overlapping with the first analog radio frequency. The method can also include, at 562, offsetting the third analog radio frequency to have a further offset frequency. The first analog radio frequency, the offset frequency, and the further offset frequency can be within a processing bandwidth of the digitizer. The processing bandwidth can be the bandwidth available for sampling. In this case, the combining can include combining the third signal with the first signal and the second signal when forming the combined signal. The digitizing can be configured to provide an output representative of the digitization of the third signal separated from the first signal and the second signal.

The method can optionally include, at 570, receiving via a third antenna, a third signal on a third analog radio frequency. In this example, the third analog radio frequency can be not overlapping with the first analog radio frequency. The method can also include, at 572, receiving, via a fourth antenna, a fourth signal on a fourth bandwidth. The fourth analog radio frequency can be at least partially overlapping with the third analog radio frequency. The method can further include, at 574, offsetting the fourth analog radio frequency to a second offset frequency. The third analog radio frequency and the second offset frequency can be within a processing bandwidth of a second digitizer. The method can additionally include, at 576, combining the third signal and the fourth signal to form a second combined signal. The method can also include, at 578, digitizing the second combined signal to provide a second output representative of a digitization of the third signal separated from the fourth signal.

The first and second digitizer can be the same physical device with multiple digitizing channels, or can be separate digitizing devices. Optionally, both the options at 560-562 and 570-578 can be used in combination, such that there can multiple digitizing channels, with at least one (and optionally more than one or all) of those digitizing channels simultaneously processing a combination of received signals in or from a same analog radio frequency as one another. These received signals can be from different antenna lines. The device can be a highly integrated device that includes multiple functionalities, including a digitizer, or can be a device that includes only a digitizer.

The method can also include, at 590, providing the digitized signals to a digital front end (DFE), for example at a serial interface of the DFE. This is also illustrated in FIGS. 2 and 3.

As a further option, this same principle could be applied to combine multiple received signals that do not have the same analog radio frequency. In such a case it may be possible to omit the offsetting. Optionally, offsetting could be used to bring a second signal closer to the bandwidth of a first signal so that both could be processed in the same digitizer. Other similar modifications are also permitted.

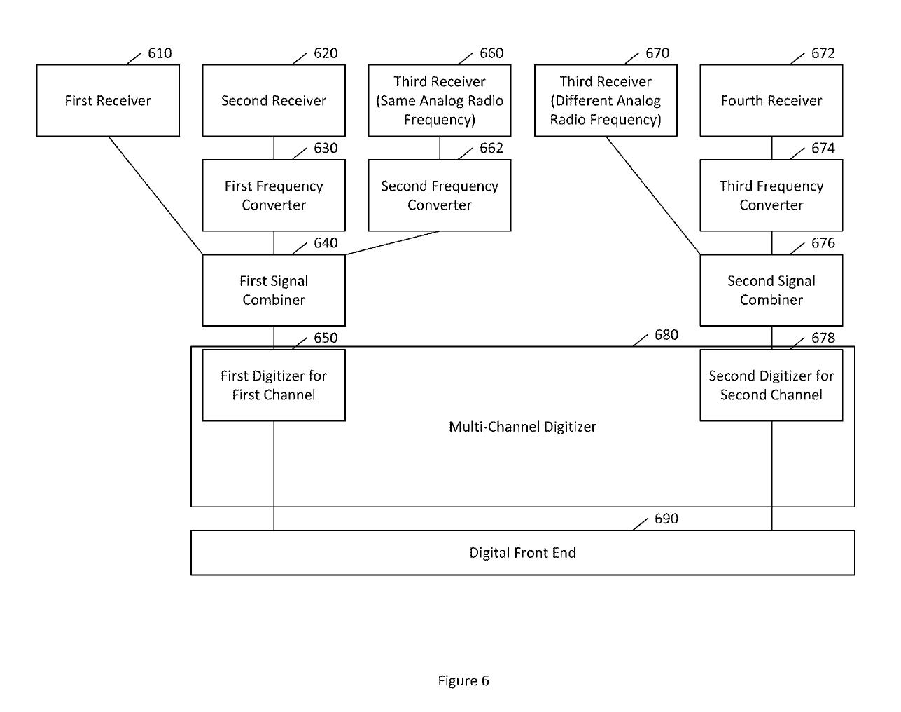

FIG. 6 illustrates a block diagram of a system according to certain embodiments. As shown in FIG. 6, a system can include a first receiver 610 configured to receive a first signal on a first analog radio frequency. The first receiver 610 can broadly include such features as, for example, an antenna, a filter, and a low-noise amplifier. The first signal can be, for example, a base station main signal and the system can be, for example, a base station. As described in connection with the method of FIG. 5, the signal can be considered the same signal even after being passed through such equipment as the optional filter and the low-noise amplifier, as illustrated in FIGS. 1 through 4.

As shown in FIG. 6, the system can also include a second receiver configured to receive a second signal on a second analog radio frequency. As with the first receiver, the second receiver can include its own antenna, filter, and low noise amplifier. The second analog radio frequency can be at least partially overlapping with the first analog radio frequency. The second signal can be, for example, a base station diversity signal. As mentioned above, the signals can be considered to be the same if, for example, when down-sampled they would overlap with one another at the baseband frequency. Other options are also permitted.

The system can further include first frequency converter 630 configured to offset the second analog radio frequency to an offset frequency. The first analog radio frequency and the offset frequency can be within a processing bandwidth of first digitizer 650. For example, as mentioned above, first digitizer 650 may have a wide processing bandwidth and the first analog radio frequency can occupy one portion of that wide processing bandwidth, while the second analog radio frequency can occupy another portion of that same wide processing bandwidth. Optionally, both the first signal and the second signal can be offset with different offsets. As mentioned above, the processing bandwidth can refer to the bandwidth available for sampling signals.

The first frequency converter 630 can include a local oscillator, which can be based on a clock of the system (not illustrated in FIG. 6). The first frequency convert 630 can also include a filter at an output thereof.

The system can additionally include a first signal combiner 640 configured to combine the first signal and the offset second signal to form a combined signal. The first digitizer 650, mentioned above, can be configured to digitize the combined signal to provide an output representative of a digitization of the first signal separated from the second signal. The separation can be made by outputting the digitized first signal in a first baseband bandwidth portion and the second signal in a second non-overlapping baseband portion. Optionally, the baseband output can be filtered to provide fully separated baseband outputs.

The system can optionally include a third receiver 660 constructed like the other receivers 610 and 620 and configured to receive a third signal on a third analog radio frequency that is the same as, for example at least partially overlapping with, the first analog radio frequency. The system can also include a second frequency converter 662 configured to offset the third analog radio frequency to have a further offset frequency. The first analog radio frequency, the offset frequency, and the further offset frequency can be within a processing bandwidth of the first digitizer 650. In this case, the combining can include combining the third signal with the first signal and the second signal when forming the combined signal. The digitizing can be configured to provide an output representative of the digitization of the third signal separated from the first signal and the second signal.

The system can optionally include a different third receiver 670 configured to receive a third signal on a third analog radio frequency different from the first analog radio frequency. The system can also include a fourth receiver 672 configured to receive a fourth signal on a fourth analog radio frequency that is at least partially overlapping with the third analog radio frequency. The different third and fourth receivers 670 and 672 can be constructed similarly to the first, second, and third receivers 610, 620, and 660.

The system can further include a third frequency converter 674 configured to offset the fourth analog radio frequency to a second offset frequency. Additional further receivers and converters are also permitted as shown, for example, in FIG. 3. The third analog radio frequency and the second offset frequency can be within a processing bandwidth of a second digitizer 678.

The system can additionally a second signal combiner 676 configured to combine the third signal and the fourth signal to form a second combined signal. The second digitizer 678 can be configured to digitize the second combined signal to provide a second output representative of a digitization of the third signal separated from the fourth signal.

The first and second digitizer can be the same physical device with multiple digitizing channels, shown as multi-channel digitizer 680, or can be separate digitizing devices. Optionally, both the options at 660-662 and 670-678 can be used in combination, such that there can multiple digitizing channels, with at least one (and optionally more than one or all) of those digitizing channels simultaneously processing a combination of received RF-signals in a same digitizing bandwidth as one another. The multiple digitizing channels can be separated from each other.

The system can also include a digital front end 590. The DFE 590 can be provided with, for example, a serial interface, as illustrated, for example, in FIGS. 2 and 3.

As a further option, this same system could be applied to combine multiple received signals that do not have the same frequency. In such a case it may be possible to omit the frequency converter(s). Optionally, a frequency converter could be used to bring a second signal closer to the bandwidth of a first signal so that both could be processed in the same digitizer. Other similar modifications are also permitted.

The various connections between parts illustrated in the figures can be accomplished in a variety of ways, such as by feed lines, transmission lines, waveguides, wires, leads, or circuit board traces, as may be appropriate. For differential signaling, for example, of digital values, pairs of wires or the like can be employed. For example, there can be an optical link between a digitizer and a digital front end (DFE).

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
receiving, via a first antenna, a first signal on a first analog radio frequency;
applying a first filter to the first signal;
receiving, via a second antenna, a second signal on a second analog radio frequency, wherein the second analog radio frequency is at least partially overlapping with the first analog radio frequency;
applying a second filter the second signal;
offsetting the second analog radio frequency to an offset frequency, wherein the first analog radio frequency and the offset frequency are within a processing bandwidth of a digitizer;
combining the filtered first signal and the filtered and offset second signal to form a combined signal;
digitizing the combined signal to provide an output representative of a digitization of the first signal separated from the second signal; and
providing the separated first signal and second signal from the digitizing to a digital front end.

2. The method of claim 1, wherein the first signal comprises a base station main signal.

3. The method of claim 1, wherein the second signal comprises a base station diversity signal.

4. The method of claim 1, further comprising:
receiving via a third antenna, a third signal on a third analog radio frequency, wherein the third analog radio frequency is at least partially overlapping with the first analog radio frequency; and
offsetting the third analog radio frequency to have a further offset frequency, wherein the first analog radio frequency, the offset frequency, and the further offset frequency are within a processing bandwidth of the digitizer,
wherein the combining comprises combining the third signal with the first signal and the second signal when forming the combined signal, and
wherein the digitizing is configured to provide an output representative of the digitization of the third signal separated from the first signal and the second signal.

5. The method of claim 1, further comprising:
receiving via a third antenna, a third signal on a third analog radio frequency, wherein the third analog radio frequency is not overlapping with the first analog radio frequency;
receiving, via a fourth antenna, a fourth signal on a fourth analog radio frequency, wherein the fourth analog radio frequency is at least partially overlapping with the third analog radio frequency; and
offsetting the fourth analog radio frequency to a second offset frequency, wherein the third analog radio frequency and the second offset frequency are within a processing bandwidth of a second digitizer;
combining the third signal and the fourth signal to form a second combined signal; and
digitizing the second combined signal to provide a second output representative of a digitization of the third signal separated from the fourth signal.

6. (canceled)

7. An apparatus, comprising:
a first receiver configured to receive a first signal on a first analog radio frequency;
a first filter configured to filter the first signal;
a second receiver configured to receive a second signal on a second analog radio frequency, wherein the second analog radio frequency is at least partially overlapping with the first analog radio frequency;
a second filter configured to filter the second signal;
a first frequency converter configured to offset the second analog radio frequency to an offset frequency, wherein the first analog radio frequency and the offset frequency are within a processing bandwidth of a first digitizer;
a first signal combiner configured to combine the filtered first signal and the filtered and offset second signal to form a combined signal;
the first digitizer configured to digitize the combined signal to provide an output representative of a digitization of the first signal separated from the second signal; and
a digital front end configured to receive the separated first signal and second signal from the first digitizer.

8. The apparatus of claim 7, wherein the first signal comprises a base station main signal.

9. The apparatus of claim 7, wherein the second signal comprises a base station diversity signal.

10. The apparatus of claim 7, further comprising:
a third receiver configured to receive a third signal on a third analog radio frequency, wherein the third analog radio frequency is at least partially overlapping with the first analog radio frequency; and
a second frequency converter configured to offset the third analog radio frequency to have a further offset frequency, wherein the first analog radio frequency, the offset frequency, and the further offset frequency are within a processing bandwidth of the digitizer,
wherein the first signal combiner is configured to combine the third signal with the first signal and the second signal when forming the combined signal, and
wherein the first digitizer is configured to provide an output representative of the digitization of the third signal separated from the first signal and the second signal.

11. The apparatus of claim 7, further comprising:
a third receiver configured to receive a third signal on a third analog radio frequency, wherein the third analog radio frequency is not overlapping with the first analog radio frequency;
a fourth receiver configured to receive a fourth signal on a fourth analog radio frequency, wherein the fourth analog radio frequency at least partially overlapping with the third analog radio frequency; and
a third frequency converter configured to offset the fourth analog radio frequency to a second offset frequency, wherein the third analog radio frequency and the second offset frequency are within a processing bandwidth of a second digitizer;
a second signal combiner configured to combine the third signal and the fourth signal to form a second combined signal; and
the second digitizer configured to digitize the second combined signal to provide a second output representative of a digitization of the third signal separated from the fourth signal.

12. The apparatus of claim 7, further comprising:
a digital front end configured to receive an output of the first digitizer.

13. An apparatus, comprising:
means for receiving, via a first antenna, a first signal on a first analog radio frequency;
means for filtering the first signal;
means for receiving, via a second antenna, a second signal on a second analog radio frequency, wherein the second analog radio frequency is at least partially overlapping with the first analog radio frequency;
means for filtering the second signal;
means for offsetting the second analog radio frequency to an offset frequency, wherein the first analog radio frequency and the offset frequency are within a processing bandwidth of a digitizer;
means for combining the filtered first signal and the filtered and offset second signal to form a combined signal; and
means for digitizing the combined signal to provide an output representative of a digitization of the first signal separated from the second signal; and
means for providing the separated first signal and second signal from the digitizing to a digital front end.

14. The apparatus of claim 13, wherein the first signal comprises a base station main signal.

15. The apparatus of claim 13, wherein the second signal comprises a base station diversity signal.

16. The apparatus of claim 13, further comprising:
means for receiving via a third antenna, a third signal on a third analog radio frequency, wherein the third analog radio frequency is at least partially overlapping with the first analog radio frequency; and
means for offsetting the third analog radio frequency to have a further offset frequency, wherein the first analog radio frequency, the offset frequency, and the further offset frequency are within a processing bandwidth of the digitizer,
wherein the combining comprises combining the third signal with the first signal and the second signal when forming the combined signal, and
wherein the digitizing is configured to provide an output representative of the digitization of the third signal separated from the first signal and the second signal.

17. The apparatus of claim 13, further comprising:
means for receiving via a third antenna, a third signal on a third analog radio frequency, wherein the third analog radio frequency is not overlapping with the first analog radio frequency;
means for receiving, via a fourth antenna, a fourth signal on a fourth analog radio frequency, wherein the fourth analog radio frequency is at least partially overlapping with the third analog radio frequency; and
means for offsetting the fourth analog radio frequency to a second offset frequency, wherein the third analog radio frequency and the second offset frequency are within a processing bandwidth of a second digitizer;
means for combining the third signal and the fourth signal to form a second combined signal; and
means for digitizing the second combined signal to provide a second output representative of a digitization of the third signal separated from the fourth signal.

18. (canceled)
